(19) United States
(12) Patent Application Publication
(10) Pub. No.: US 2022/0124238 A1
(43) Pub. Date: Apr. 21, 2022

(54) METHOD AND SYSTEM FOR CAPTURING STUDENT IMAGES

(71) Applicant: Sean David Paul Rutherford, Kitchener (CA)

(72) Inventor: Sean David Paul Rutherford, Kitchener (CA)

(21) Appl. No.: 17/499,178

(22) Filed: Oct. 12, 2021

Related U.S. Application Data
(60) Provisional application No. 63/094,261, filed on Oct. 20, 2020.

(51) Int. Cl. H04N 5/232; H04N 5/247; H04N 7/18

(52) U.S. Cl. CPC H04N 5/23206; H04N 7/181; H04N 5/247

(57) ABSTRACT

A method of capturing student images, including (a) setting up a central computer station of a student image capture system in a temporary environment, (b) setting up a plurality of camera stations of the student image capture system in the temporary environment, (c) tethering the camera of each camera station in the temporary environment to the central computer station in the temporary environment to send the at least one image to the central computer station for storage, and (d) monitoring, after (c), the student image capture system as each camera station automatically captures the at least one image of the student and sends the at least one image to the central computer station for storage. A student image capture system includes a central computer station and a plurality of camera stations each including a camera operable to be tethered to the central computer station.

### CROSS-REFERENCE

The present application claims benefit of U.S. Provisional Patent Application No. 63/094,261 entitled METHOD AND SYSTEM FOR CAPTURING STUDENT IMAGES, filed Oct. 20, 2020, the entirety of which is incorporated herein by reference.

### TECHNICAL FIELD

The disclosure relates to photography, and in particular, to a method and system for capturing student images.

### BACKGROUND

School photo days are a regular occurrence at many schools. Typically, a school will choose one or more days each year on which to have a team of photographers come to the school, set up one or more temporary photo-taking stations, and proceed to take one or more photos of each of most of the students at the school (e.g. all students who are not absent on the one or more chosen days). Such photos are often used for identification (e.g. student identification badges or amber alerts) or school records (e.g. year books or class photos), or are offered for sale (e.g. to the student or a parent or guardian).

Most schools choose days that are within a period of a few months in the fall of each year. Additionally, in many cases several photographers are needed to facilitate the large volume of photos that must be taken on the one or more chosen days. Consequently, many school photography operations (e.g. student photography companies) are dependent on a large number of seasonal employees that are employed for a short period of time (i.e. a few months in the fall of each year), and many school photography operations consequently have difficulty finding skilled and reliable photographers.

Even when photographers can be found, the quality of the student photos is sometimes less than optimum, at least in part because of the typical format of school photo days. The average photo session is just 30 seconds per student in order to complete the photos within a tight time period to minimize disruption of the school day. During this duration, usually only a few photos are captured by the photographer, with little opportunity for the student or photographer to review the photos before the session is over. As a result, the photographer would sometimes miss the perfect smile or best image of the student.

Further, for many photo sessions the photographer must approach the student with the camera to take the photos. Often, the photographer must also interact with the student to instruct the student in how to posture the student's body and when to smile. Thus, the photographer and student are often in close proximity during the session; often close enough for airborne pathogens to pass between the photographer and the student.

Accordingly, there is a need for improved methods and systems for capturing student images.

### SUMMARY

According to a first aspect, there is provided a method of capturing student images, comprising (a) setting up a central computer station of a student image capture system in a temporary environment, the central computer station including at least one data storage device and at least one processor communicatively coupled to the at least one data storage device to send and receive imaging data, (b) setting up a plurality of camera stations of the student image capture system in the temporary environment, each of the plurality of camera stations including a camera operable to automatically capture at least one image of a student positioned at an image capture location adjacent the camera; (c) tethering the camera of each camera station in the temporary environment to the central computer station in the temporary environment to send the at least one image to the central computer station for storage; and, (d) monitoring, after (c), the student image capture system as each camera station automatically captures the at least one image of the student and sends the at least one image to the central computer station for storage.

In some examples, the method further comprises taking down the student image capture system after (d) in preparation for moving the student image capture system to another temporary environment.

For each of the plurality of camera stations the camera may be a video camera and the at least one image of the student may include a video of the student.

The video may have a length between 10 seconds and 40 seconds.

The method may further comprise processing the plurality of videos of the plurality of camera stations to determine at least one recommended still frame from each video for use as a portrait photo.

The central computer station may process the plurality of videos to determine the at least one recommended still frame from each video.

The plurality of videos may be transferred from the student image capture system to at least one external processor to be processed to determine the at least one recommended still frame from each video.

The central computer station may include at least one monitoring screen to provide status information about the student image capture system for use in monitoring the student image capture system.

Each camera station may be operable to present an instruction to the student and the camera may be operable to capture the at least one image of the student as the student responds to the instruction.

Each camera station may include an instructions screen and at least one processor and the instruction may be an instruction video, wherein the at least one processor is operatively coupled to the instructions screen and operable to run the instruction video on the instructions screen.

At (b) the plurality of camera stations may each be set up at least a distance away from the central computer station and each set up at least the distance away from each other camera station of the plurality of camera stations, the distance being at least one meter.

According to a second aspect, there is provided a student image capture system to be temporarily set up in an environment and capture a portrait of each of a plurality of students while monitored by an operator, the student image capture system comprising a central computer station to be set up in the environment, the central computer station including at least one data storage device, and at least one processor communicatively coupled to the at least one data storage device to send and receive imaging data; and a plurality of camera stations to be set up in the environment along with the central computer station, each camera station including an instruction to be presented to a student of the plurality of students when the student is positioned in the environment at an image capture location adjacent the camera station, and a camera operable to be tethered to the central computer station, the camera further operable, while tethered to the central computer station, to capture at least one image of the student as the student responds to the instruction, and send the at least one image directly to the central computer station for storage.

In some examples, the operator is a single operator, and the student image capture system is sized and shaped to be set up in the environment by the single operator, monitored in the environment by the single operator, and taken down by the single operator.

Each camera station may be set up at least a distance from the central computer station and at least the distance from each other camera station, wherein the distance is at least one meter.

For each camera station of the plurality of camera stations the camera may be a video camera and the at least one image may include a video.

The video may be between 10 seconds and 40 seconds in length.

The central computer station may process the plurality of videos of the plurality of camera stations to determine at least one recommended still frame from each video for use as a portrait photo.

The central computer station may include at least one monitoring screen communicatively coupled to the at least one processor to receive and display information on a status of the student image capture system for use by the operator in monitoring the student image capture system.

The instruction may be an instruction video and each camera station of the plurality of camera stations may include an instructions screen operable to display the instruction video to the subject, and the camera of each camera station of the plurality of camera stations may be operable to capture the at least one image of the subject as the subject responds to the instruction.

According to a third aspect, there is provided a student image capture system comprising a central computer station set up in a temporary environment, the central computer station including: at least one data storage device, and at least one processor communicatively coupled to the at least one data storage device to send and receive imaging data; and a plurality of camera stations set up in the temporary environment along with the central computer station, each camera station including: a screen to present a video instruction to a student when the student is positioned in the temporary environment at an image capture location adjacent the camera station, and a camera tethered to the central computer station, the camera operable to: capture at least one image of the student as the student responds to the video instruction, and send the at least one image directly to the central computer station for storage; and wherein the central computer station is operable to receive the images from the plurality of cameras and store the images on the at least one data storage device.

### BRIEF DESCRIPTION OF THE DRAWINGS

The drawings included herewith are for illustrating various examples of systems, methods, and apparatus of the present specification. In the drawings:

FIG. 1 is a flow chart of a method of capturing student images;

FIG. 2 is a schematic diagram of a first student image capture system;

FIG. 3 is a schematic diagram of a second student image capture system;

and

FIG. 4 is a flow chart of a method implemented by the system of FIG. 3.

### DETAILED DESCRIPTION

Various apparatus or processes will be described below to provide an example of each claimed embodiment. No example described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatus or processes described below.

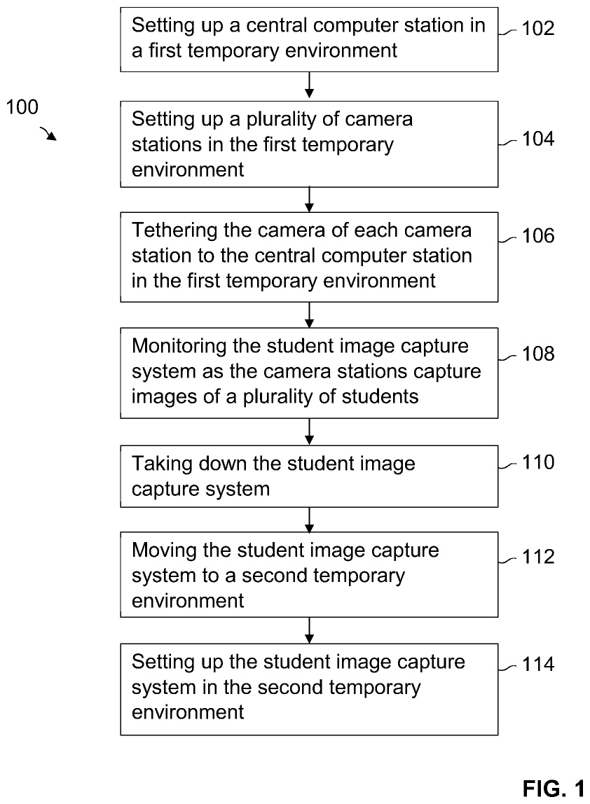

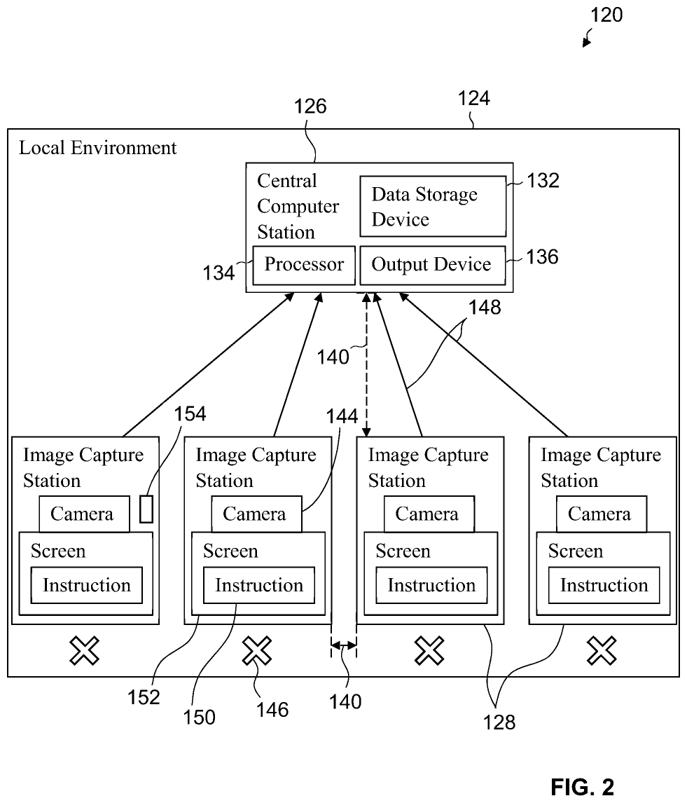

Referring now to FIG. 1, illustrated therein is an example of a method 100 of capturing student images. The method 100 includes setting up a student image capture system 120 (FIG. 2) in a temporary environment 124 (FIG. 2). For example, the student image capture system 120 may be set up in a school gym, library, or other room or space that is temporarily given over to be used in capturing student images (i.e. generally used for other purposes).

Referring now to FIG. 2, illustrated therein is an example student image capture system 120. The student image capture system 120 includes a central computer station 126 and one or more interactive camera stations 128. Both the central computer station 126 and the one or more camera stations 128 may be set up in the temporary environment 124.

Since the student image capture system 120 is regularly moved between temporary locations, it may be configured (e.g. sized and shaped) to be easily set up and taken down (e.g. to be set up and taken down by a single operator). For example, the camera station(s) 128 and/or central computer station 126 may not include a housing (e.g. an anti-tamper housing) or other bulky features. In another example, the student image capture system 120 may not include a comprehensive set of directions for students (e.g. an automated system to tell students which camera station 128 to go to), at least in part because the relative positions of the central computer station 126 and the camera stations 128 may be different in different temporary environments (e.g. no comprehensive set of directions can be used across all temporary environments). Accordingly, one or more operators may be needed to monitor the student image capture system 120.

In some examples, the student image capture system 120 is monitored by a single operator, and may be configured to be set up, monitored while taking student images, and taken down by the single operator. The operator(s) may be required to ensure the student image capture system 120 is operating properly and/or is not tampered with. For example, the operator(s) may tell students which camera station 128 to go to, answer questions from students, or prevent students from adjusting components of the camera stations 128. In some examples, the operator may monitor the student image capture system 120 from the central computer station 126, and may optionally receive status information at the central computer station 126 as discussed further elsewhere herein.

Each camera station 128 may be operable to perform an imaging session with a student, in which the camera station captures at least one image of a student automatically and sends the at least one image to the central computer station 126 automatically, as discussed further elsewhere herein. As a result, the operator does not need to devote their attention to a single camera station 128, and can monitor a student image capture system 120 that includes multiple camera stations 128. Accordingly, while at least one operator may be required to monitor the system as discussed previously, the labor costs for a school photo operation can be substantially reduced by having a plurality of camera stations 128 so that a single operator (or, at least, less operators than camera stations 128) can monitor multiple imaging sessions and/or students at a time. Accordingly, school photography operations (e.g. companies running school photo days) may be able to operate with a smaller work force. As a result, labor costs may be reduced. For example, if a single operator is able to monitor a student image capture system 120 having four camera stations 128 the labor costs to the student photography operation may be reduced by approximately 75%. The plurality of camera stations 128 may accordingly result in significant savings and reduced costs.

Referring still to FIG. 2, the central computer station 126 is illustrated in the temporary environment 124. The central computer station 126 includes at least one data storage device 132 and at least one processor 134. The at least one processor 134 and the at least one data storage device 132 are communicatively coupled (e.g. to transfer student images and other imaging data therebetween). The at least one processor 134 and the at least one data storage device 132 may be communicative coupled by a wired or wireless link (e.g. a computer system bus).

Optionally, the central computer station 126 may include an output device 136 to provide status information about the student image capture system 120 for use in monitoring the student image capture system 120. The status information may include, for example, information about the operational status of a particular camera station 128 or the central computer station 126 (e.g. whether the at least one data storage device is filled to capacity or whether the components of the camera station 128 are operating properly). The status information may also or alternatively include information about an imaging session at a particular camera station 128 (e.g. the status information may include an image captured at the camera station 128 so that the operator can review image quality, or the status information may include information about the student such as the student's name).

The central station output device 136 of the central computer station 126 may be, for example, a transceiver to transmit the status information to an external device (e.g. the operator's smartphone or tablet), a microphone to provide status announcements or alerts, or, as in the illustrated example, a screen to display the status information. For example, the central station output device 136 may include one or more screens to display the one or more images (e.g. a 15 inch monitor to allow the operator to view an image in greater detail than on the screen of a camera).

Accordingly, in addition to storing the at least one images, the central computer station 126 may be a monitoring station (e.g. with one or more screens showing status information) to be used by the operator to help ensure each camera station 128 is operating properly.

Each camera station 128 of the one or more camera stations 128 is also illustrated in the temporary environment 124. Optionally, each camera station 128 may be set up at least a distance 140 away from the central computer station 126. As discussed further elsewhere herein, each camera station 128 may be configured to operate largely automatically so that the operator of the student image capture system 120 does not need to approach the camera station 128 (e.g. the operator does not need to press a button at the camera station 128 or approach the camera station 128 to tell the student what to do). Accordingly, if the operator is monitoring the student image capture system 120 from the central computer station 126, a student at the camera station 128 may be at least the distance 140 away from the operator.

The distance 140 may be chosen to be at least a minimum distance required for safe interaction, such as a distance suggested by a health authority for minimizing a chance of a transfer of a virus (e.g. to minimize the risk of transferring a coronavirus disease between the operator and the student). For example, the distance 140 may be at least one meter or at least 1.8 meters (e.g. at least a “social distancing” distance). The distance 140 may permit the tradition of the school photo day to continue (e.g. to provide updated photos to schools) while reducing the risk of disease transfer. Optionally, each camera station 128 may also be at least the distance 140 from each other camera station 128.

Each camera station 128 includes a camera 144 to capture the at least one image of the student (e.g. at least one image to be used to create a profile photo of the student, such as a photo of the front of a student's head and shoulders). When the camera station 128 is set up, the camera 144 is arranged to capture one or more images of a student positioned at an image capture location 146 adjacent the camera 144. A marker may optionally be provided at the image capture location 146 to show the student where to stand (e.g. a sticker shaped like footprints to show the student where to place their feet).

Optionally, the camera 144 may be a video camera operable to capture a video of the student positioned at the image capture location 146. The one or more images of the student may include the video of the student. The video camera 144 may be configured to capture a short video of the student, such as a video with a length between 10 seconds and 40 seconds, between 20 seconds and 30 seconds, or approximately 30 seconds. The video may be captured in addition to one or more still shots or in alternative to one or more still shots. For example, the at least one image of the student may consist only of the video in some examples, from which one or more frames can be extracted for use as portrait photos.

The video may optionally be automatically processed to determine one or more recommended still frames for use as portrait photos. At least one processor (e.g. the at least one processor 134 of the central computer station 126 and/or one or more alternative processors such as a processor of an external server that the video is transferred to from the central computer station 126) may be configured to determine one or more recommended frames of the video. For example, after the student image capture system 120 has taken at least one video of each of a plurality of students and stored the videos on the at least one data storage device 132 of the central computer station 126, the videos may be transferred to one or more external data storage devices (e.g. a remote server or a data storage device at a production facility of a student photography operation), from where the processor(s) used to determine the frame(s) may access the videos.

The processor(s) used to determine the one or more frames from the video may be configured to choose the frame(s) by automatically identifying frame(s) that show the student and have desirable characteristics (e.g. the student is smiling, the student's eyes are open, the brightness and contrast of the frame is appropriate, etc.). In some examples, the processor(s) used to determine one or more frames from the video may include an artificial intelligence configured to recognize facial expressions and/or to recognize a student and the set of desirable characteristics (e.g. a neural network trained to recognize a student and the set of desirable characteristics). The processor(s) used to determine the one or more frames from the video may be configured to select a single preferred frame or a set of recommended frames (e.g. between 2 and 50 frames, between 2 and 10 frames, between 2 and 5 frames, or about 3 frames).

The preferred frame or the set of recommended frames and/or altered versions (e.g. low-quality versions or watermarked versions) may then be provided to a third party, such as to the school for use in student identification or school records or to the student or a guardian along with an offer to sell higher-quality versions. In examples in which the student image capture system 120 captures a video, the chances of producing a portrait photo worth purchasing may increase significantly as compared to a photographer capturing a few still shots. Since the video includes many images taken over at least several seconds, the video may contain images showing many more expressions than those visible in the milliseconds that the photographer would otherwise capture. Additionally or alternatively, a video may eliminate the need for the skill of a photographer in identifying and capturing good images.

A camera is tethered to a computer when the camera is operatively coupled to the computer via a wired or wireless connection to pass an image captured by the camera directly to the computer to be viewed, processed, and/or stored. In some cases, a tethered camera can also be controlled by the computer to which it is tethered (e.g. settings can be adjusted or the camera can be directed as to when to capture an image or images/video). When the student image capture system 120 is set up in the temporary environment 124 each camera 144 is tethered to the central computer station 126 to send the at least one images to the central computer station 126 for storage. The cameras 144 may be tethered to the central computer station 126 via a wireless link or, as in the illustrated example, via a wired link 148. The tethered cameras 144 may be operable to send the at least one images directly to the central computer station 126 for storage, optionally without storing the at least one images on the camera 144. For example, the cameras 144 may be communicatively coupled to the at least one processor 134 to send the at least one images to the at least one processor 134, and the at least one processor 134 may then be configured to send the at least one images to the at least one data storage device 132.

Optionally, each camera station 128 includes an instruction 150 to be presented to the student positioned in the temporary environment 124 at the image capture location 146 (e.g. so that the operator(s) does not need to interact with the student to instruct the student). The instruction 150 may be supplemented by other directions presented to the student, such as a sign to be seen by the student as the student moves towards the camera station 128 (e.g. a sign pointing to the image capture location 146 and directing the student to move towards the image capture location 146). As discussed elsewhere herein, the relative positioning of the central computer station 126 and the camera stations 128 may be different in different temporary environments, however the instructions needed once the student is at the image capture location 146 may be consistent across different temporary environments.

The instruction 150 may be, for example, a symbol or text providing guidance to the student regarding the student's posture or the timing of the student's smile. For example, the instruction 150 may be printed on a sheet of paper and indicate that the student should smile towards the camera 144. The instruction 150 may provide the student with guidance regarding each step the student should take from arriving at the image capture location to the end of the imaging session (e.g. so the operator is not needed at the camera station). The instruction 150 may optionally include a marker placed at the image capture location 146 (e.g. a sticker to be stuck to a gym floor, the sticker depicting a pair of footprints over which the student is to place their feet).

Optionally, each camera station 128 may include a camera station output device, such as an instruction screen 152. The instruction screen 152 may present the instruction 150. The instruction 150 may optionally include a video. For example, the instruction 150 may be a video of an individual telling the student to place their feet on the sticker located at the image capture location 146 and smile towards the camera 144. The instruction 150 may be an age appropriate video (e.g. more detailed when photographing younger students), and may include one or more questions, statements, or images (e.g. to cause a pleasant reaction; for example, jokes or statements intended to cause or direct the student to relax and/or smile). The instruction 150 may be an interactive video (e.g. allowing the student to indicate when they are ready for the camera 144 to begin taking the at least one image).

The camera 144 may be configured to capture the at least one image of the student automatically. For example, the camera station 128 may optionally include one or more sensors 154 to detect the presence of an individual at the image capture location 146, and may subsequently present an instruction towards the image capture location 146 and then proceed to begin capturing the at least one image of the individual at the image capture location 146. The camera station 128 may automatically be reconfigured in response to signals received by the one or more sensors 154 (e.g. the camera may be moved up or down to center the camera on the head of the student, if the height of the student is not compatible with the current camera position). The camera station 128 may be configured to run a predetermined routine (e.g. beginning to capture the video a few seconds after the individual arrives at the image capture location 146), and may present information about the routine towards the image capture location (e.g. the instruction screen 152 may direct the individual to smile and inform the individual that the video will begin in a predetermined number of seconds, such as 5 seconds).

Alternatively or additionally to a predetermined and/or automatic routine, the camera station 128 may be interactive. For example, the camera station 128 may begin to record the video in response to a command (e.g. a button press or a voice command) from an individual, such as from the student located at the image capture location 146. The student may be able to move to the image capture location 146 and indicate when they are ready for the camera 144 to take the one or more images (e.g. when they are ready for the camera 144 to take a 30 second video). The student may interact with the camera station 128 via the instruction screen 152, such as if the instruction video is interactive and presents an opportunity for the student to provide input (e.g. selecting a digital button to indicate they are ready).

Referring again to FIG. 1, the method 100 includes, at step 102, setting up the central computer station 126 in the temporary environment 124. The method 100 also includes, at step 104, setting up the plurality of camera stations 128 in the temporary environment 124. As discussed elsewhere herein, each camera station 128 may optionally be set up at least the distance 140 from the central computer station 126, and may optionally be set up at least the distance 140 from each other camera station 128.

The method 100 also includes, at step 106, tethering the camera of each camera station 128 in the temporary environment 124 to the central computer station 126 in the temporary environment 124 to send the at least one image to the central computer station 126. Optionally, in addition to sending the at least one image directly to the central computer station 126, the tethered camera 144 may be adjusted and/or controlled from the central computer station 126.

The method 100 also includes, at step 108, monitoring the student image capture system 120 as each camera station 128 captures the at least one image of the student and sends the at least one image to the central computer station 126 for storage. Step 108 may be performed after step 106. For example, the single operator may set up the student image capture system 120 with a plurality of camera stations 128 (e.g. four camera stations 128), and then monitor the student image capture system 120 as each camera station 128 captures at least one image of at least one student.

Optionally, the method 100 includes, at step 110, taking down the student image capture system 120 in preparation for moving the student image capture system 120 from the temporary environment 124 to another temporary environment. Step 110 may be performed after step 108. The method 100 also optionally includes, at step 112, subsequent to step 110, moving the student image capture system 120 to a second temporary environment different from the first temporary environment 124. The method 100 also optionally includes, at step 114, setting up the student image capture system 120 in the second temporary environment for use in imaging a second plurality of students other than the first plurality of students imaged in the first temporary environment 124.

For example, the single operator may set up the student image capture system 120 in a gym of a first school, monitor the student image capture system 120 as it captures images (e.g. videos) of a plurality of students, and then take down the student image capture system 120 so that the student image capture system 120 can be moved to a gym of a second school to capture images of a different set of students. Optionally, steps 102, 104, 106, and 108 (and, optionally, step 110) may be performed in a single day or over the course of a few (e.g. three or less) consecutive days.

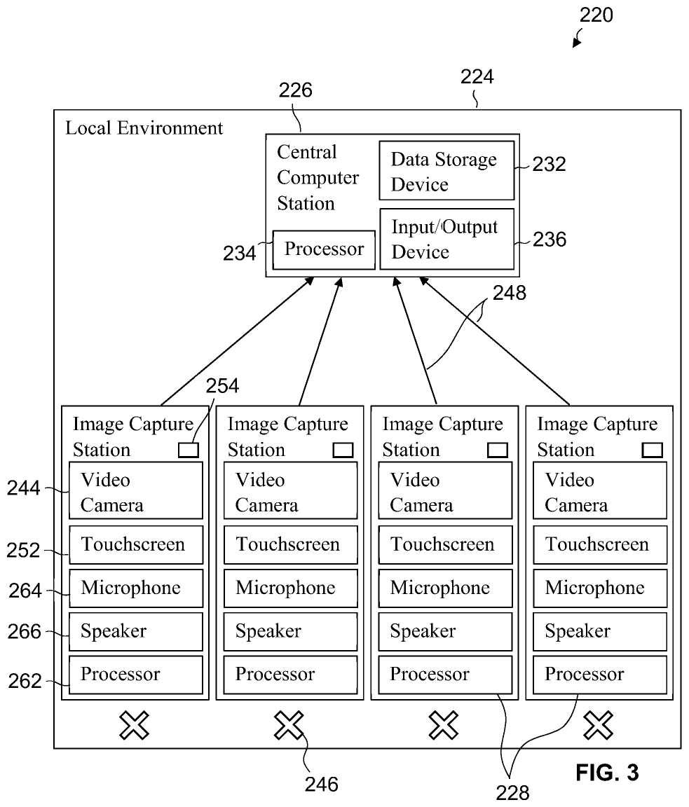

Referring now to FIG. 3, illustrated is a second example of a student image capture system 220. The student image capture system 220 is similar in many respects to the student image capture system 120, and like features are indicated by like reference numbers, incremented by 100.

The student image capture system 220 is a highly automated system. The system 220 may include a plurality of image capture stations 228, however image capture stations 228 each include at least one output device for providing instructions and/or information to the student (e.g. touchscreen 252 or speaker 266) and at least one input device for receiving feedback from the student (e.g. touchscreen 252 or microphone 264). At least one processor 262 is provided to run the input and output devices of the image capture station 228 (e.g. to run an instruction video on the touchscreen 252 and receive feedback from the student by recognizing student touches on the touchscreen 252).

In the illustrated example, each image capture station 228 includes a video camera 244. The at least one processor 262 is operatively coupled to the video camera 244 to control when the video camera 244 captures an image and/or video and to direct where the image and/or video is sent. The at least one processor 262 is operatively coupled to at least one sensor 254 to receive sensor readings, such as an indication that a student is at the image capture location 246. For example, the at least one processor 262 may be operable to begin a photo session and/or operate the video camera 244 only when (i.e. not unless) and/or in response to (i.e. as soon as) receiving a single from the sensor 254 indicating the presence of a student at the image capture location 246.

The at least one processor 262 is also operatively coupled to each of the touchscreen 252, microphone 264, and speaker 266. The at least one processor 262 may be operable to run an instruction video on the touchscreen 252, receive audio feedback from the user via the microphone 264, and/or provide audio instruction to the user via the speaker 266. For example, the at least one processor 262 may be operable to run a video on the touchscreen 252 and play associated audio on the speaker 266 for a student located at the image capture location 246, and then and/or concurrently receive tactile feedback from the student via the touchscreen 252 and/or audio feedback from the student via the microphone 264. The at least one processor 262 may operate the video camera 244 to capture a short (e.g. 20 to 30 second) video of the student at the image capture location 246. The at least one processor 262 may be operable to send the short video of the student to the central computer station 226 (e.g. via the wired link 248).

At the central computer station 226 the at least one processor 234 of the central computer station 226 may be operable to receive the short video from the at least one processor 262 of the image capture station 228 and store the short video on the at least one data storage device 232. The central computer station 226 may be monitored via an input/output device 236, such as a transceiver operable to be coupled to a mobile device (e.g. a smartphone) or a touchscreen or combination of screen and keyboard or curser (e.g. a computer mouse controlling a cursor on the screen).

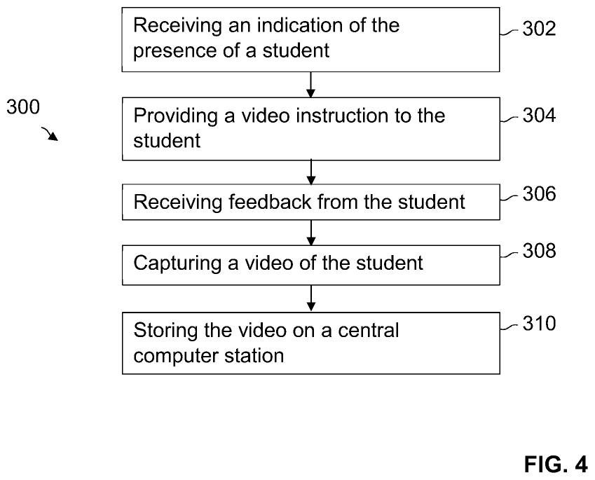

Referring now to FIG. 4, a student image capture system such as the student image capture system 220 of FIG. 3 may implement a method 300. The method 300 includes, at step 302, receiving an indication of the presence of a student. The indication may come by way of a sensor (e.g. at least one sensor 254). Additionally or alternatively, the indication may come from an operator (e.g. via input at input/output device 236 of central computer station 226) and/or from the student (e.g. via tactile and/or audio feedback provided via the touchscreen 252 and/or microphone 264).

Once the indication of the presence of the student has been received, the method 300 includes, at step 304, providing a video instruction to the student. At step 306, the method 300 includes receiving feedback from the student. Steps 304 and 306 may be sequential and/or concurrent, and may be repetitive. For example, the method 300 may include presenting a video and associated audio to the student stating that the system is ready to take a short video of the student and asking the student to indicate whether the student is ready for the photo session to begin. Following the student's indication that the student is ready for the photo session to begin (e.g. video tactile and/or audio feedback), the method 300 may include presenting a video and associated audio telling the student that the video will begin to be recorded in a predetermined length of time (e.g. less than 100 seconds, less than 30 seconds, or around 10 seconds). The method 300 may include counting down the remaining time of the predetermined length of time (e.g. counting down the full time or the last several seconds, audibly or via an on-screen display).

The video and associated audio may also or alternatively direct the student regarding posture and/or provide tips (e.g. look towards the camera or look off to the left of the camera). In some examples, the method 300 may wait for a further feedback from the student indicating that the student is ready for the video to be recorded (e.g. the student stating “ready” after the instructions video has told the student where to look).

At step 308, the method 300 includes capturing a video of the student (e.g. capturing a video of the student located at the image capture location 246, using the video camera 244). In some examples, steps 308, 306, and/or 304 are carried out concurrently. For example, the system (e.g. system 220) may instruct (e.g. audibly using speaker 266) the student to first look at the camera, then look to the right side, then look to the left side. In some examples, the student may be able to provide concurrent feedback regarding the type of video they would like to have. For example, the student may directing the system to zoom in to take at least a portion of the video as a close shot of the students face. In another example, the student may respond to options presented by the system during the video taking (e.g. saying “yes” or “no” if the system presents the question “would you like to pay for an additional 30 seconds of video capture”).

Once the video is captured, the method 300 includes, at step 310, storing the video on a central computer station. The video may be captured by an image capture station (e.g. image capture station 228) of a plurality of image capture stations, with each image capture station tethered to a central computer station to send the video(s) captured by the image capture stations to the central computer station directly. The central computer station may optionally be a monitoring station for an operator (e.g. a photographer) to monitor the system.

The operator may be present to watch the method 300 taking place. The method 300 may take place in a temporary environment (e.g. set up in a school gym or library), and the system may be configured for use as a temporary set up (e.g. without protective housings and/or complete instructions for students). Accordingly, the operator may be needed to observe the system during the method 300, and the operator may optionally observe the system from the central computer station (i.e. monitoring station).

The present invention has been described here by way of example only. Various modification and variations may be made to these examples without departing from the scope of the invention, which is limited only by the appended claims.

1. A method of capturing student images, comprising:
(a) setting up a central computer station of a student image capture system in a temporary environment, the central computer station including at least one data storage device and at least one processor communicatively coupled to the at least one data storage device to send and receive imaging data,
(b) setting up a plurality of camera stations of the student image capture system in the temporary environment, each of the plurality of camera stations including a camera operable to automatically capture at least one image of a student positioned at an image capture location adjacent the camera;
(c) tethering the camera of each camera station in the temporary environment to the central computer station in the temporary environment to send the at least one image to the central computer station for storage; and,
(d) monitoring, after (c), the student image capture system as each camera station automatically captures the at least one image of the student and sends the at least one image to the central computer station for storage.

2. The method of claim 1, further comprising taking down the student image capture system after (d) in preparation for moving the student image capture system to another temporary environment.

3. The method of claim 1, wherein for each of the plurality of camera stations the camera is a video camera and the at least one image of the student includes a video of the student.

4. The method of claim 3, wherein the video has a length between 10 seconds and 40 seconds.

5. The method of claim 3, further comprising processing the plurality of videos of the plurality of camera stations to determine at least one recommended still frame from each video for use as a portrait photo.

6. The method of claim 5, wherein the central computer station processes the plurality of videos to determine the at least one recommended still frame from each video.

7. The method of claim 5, wherein the plurality of videos are transferred from the student image capture system to at least one external processor to be processed to determine the at least one recommended still frame from each video.

8. The method of claim 1, wherein the central computer station includes at least one monitoring screen to provide status information about the student image capture system for use in monitoring the student image capture system.

9. The method of claim 1, wherein each camera station is operable to present an instruction to the student and the camera is operable to capture the at least one image of the student as the student responds to the instruction.

10. The method of claim 9, wherein each camera station includes an instructions screen and at least one processor and the instruction is an instruction video, wherein the at least one processor is operatively coupled to the instructions screen and operable to run the instruction video on the instructions screen.

11. The method of claim 1, wherein at (b) the plurality of camera stations are each set up at least a distance away from the central computer station and each set up at least the distance away from each other camera station of the plurality of camera stations, the distance being at least one meter.

12. A student image capture system to be temporarily set up in an environment and capture a portrait of each of a plurality of students while monitored by an operator, the student image capture system comprising:
(a) a central computer station to be set up in the environment, the central computer station including:
(i) at least one data storage device, and
(ii) at least one processor communicatively coupled to the at least one data storage device to send and receive imaging data; and
(b) a plurality of camera stations to be set up in the environment along with the central computer station, each camera station including:
(i) an instruction to be presented to a student of the plurality of students when the student is positioned in the environment at an image capture location adjacent the camera station, and
(ii) a camera operable to be tethered to the central computer station, the camera further operable, while tethered to the central computer station, to:
a. capture at least one image of the student as the student responds to the instruction, and
b. send the at least one image directly to the central computer station for storage.

13. The student image capture system of claim 12, wherein the operator is a single operator, and the student image capture system is sized and shaped to be set up in the environment by the single operator, monitored in the environment by the single operator, and taken down by the single operator.

14. The student image capture system of claim 12, wherein each camera station is set up at least a distance from the central computer station and at least the distance from each other camera station, wherein the distance is at least one meter.

15. The student image capture system of claim 12, wherein for each camera station of the plurality of camera stations the camera is a video camera and the at least one image includes a video.

16. The student image capture system of claim 15, wherein the video is between 10 seconds and 40 seconds in length.

17. The student image capture system of claim 15, wherein the central computer station processes the plurality of videos of the plurality of camera stations to determine at least one recommended still frame from each video for use as a portrait photo.

18. The image capture system of claim 12, wherein the central computer station includes at least one monitoring screen communicatively coupled to the at least one processor to receive and display information on a status of the student image capture system for use by the operator in monitoring the student image capture system.

19. The student image capture system of claim 12, wherein the instruction is an instruction video and each camera station of the plurality of camera stations includes an instructions screen operable to display the instruction video to the subject, and the camera of each camera station of the plurality of camera stations is operable to capture the at least one image of the subject as the subject responds to the instruction

20. A student image capture system comprising:
(a) a central computer station set up in a temporary environment, the central computer station including:
(i) at least one data storage device, and
(ii) at least one processor communicatively coupled to the at least one data storage device to send and receive imaging data; and
(b) a plurality of camera stations set up in the temporary environment along with the central computer station, each camera station including:
(i) a screen to present a video instruction to a student when the student is positioned in the temporary environment at an image capture location adjacent the camera station, and
(ii) a camera tethered to the central computer station, the camera operable to:
c. capture at least one image of the student as the student responds to the video instruction, and
d. send the at least one image directly to the central computer station for storage; and
wherein the central computer station is operable to receive the images from the plurality of cameras and store the images on the at least one data storage device.
